(19) United States
(12) Patent Application Publication
(10) Pub. No.: US 2022/0012089 A1
(43) Pub. Date: Jan. 13, 2022

(54) SYSTEM FOR COMPUTATIONAL RESOURCE PREDICTION AND SUBSEQUENT WORKLOAD PROVISIONING

(71) Applicant: Accenture Global Solutions Limited, Dublin (IE)

(72) Inventors: Mohamad Mehdi NASR-AZADANI, San Francisco, CA (US); Andrew Hoonsik NAM, San Francisco, CA (US); Yao A. YANG, Sunnyvale, CA (US); Kirby James LINVILL, Santa Clara, CA (US); Teresa Sheausan TUNG, Tustin, CA (US)

(21) Appl. No.: 17/362,591

(22) Filed: Jun. 29, 2021

Related U.S. Application Data
(60) Provisional application No. 63/051,167, filed on Jul. 13, 2020.

(51) Int. Cl. G06F 9/48; G06N 3/12; G06N 5/04; G06N 7/00; G06F 9/50

(52) U.S. Cl. CPC G06F 9/48; G06N 3/126; G06F 2209/505; G06N 7/005; G06F 9/5027; G06N 5/04

(57) ABSTRACT

The present disclosure describes a system, a method, and a product for computational resource prediction of user tasks and subsequent workload provisioning. The computational resource predictions for a user task is achieved using a twin machine learning and AI system based on probabilistic programing. The workload scheduling and assignment of the user task in a computing cluster with components having diverse hardware architectures are further managed by an automatic and intelligent assignment/provisioning engine based on various machine learning and AI models and reinforcement learning. The automatic workload scheduling and assignment engine is further configured to handle unpredicted uncertainty and adapt to constantly evolving system queues of the tasks submitted by the users to generate queuing/re-queuing, running/termination, and resource allocation/reallocation actions for user tasks.

### CROSS REFERENCE

This application is based on and claims priority to the U.S. Provisional Application No. 63/051,167 filed on Jul. 13, 2020, which is herein incorporated by reference in its entirety.

### TECHNICAL FIELD

The present disclosure relates generally to machine learning and artificial intelligence (AI), and particularly to automatic computational resource prediction, resource-aware model tuning, and subsequent workload provisioning of AI tasks.

### BACKGROUND

Modern applications/tasks may be deployed in a shared cluster of computing resources at scale. Such applications/tasks may rely on various machine learning and AI models that require careful configuration, training, and tuning. Performances of these machine learning and AI models usually correlate with complexity of these models, which may dictate the amount of computing resource consumption. Efficiency and accuracy in dynamic allocation and provisioning of computing resources shared by a large number of machine learning and AI models are thus critical for achieving an acceptable overall performance metrics constrained by resource availability.

### DRAWINGS

To assist in understanding of the various implementations described in this disclosure, reference is made to the following accompanying drawings:

FIG. 1 shows an electronic communication environment for implementing computational resource prediction, resource-aware model tuning, and subsequent workload provisioning in a computer cluster;

FIG. 2 shows a computer system that may be used to implement various components of the electronic communication environment of FIG. 1 in one form of the present disclosure;

FIG. 3 shows a traditional work flow for computational resource prediction, resource-aware model tuning, and subsequent workload provisioning of user tasks in a computer cluster.

FIG. 4 shows an automatic computational resource prediction and subsequent workload provisioning of user tasks in a computer cluster.

FIG. 5 shows a resource prediction twin trained based on machine learning models.

FIG. 6 illustrates a generative model for computing source prediction based on probabilistic programing and inference.

FIG. 7 shows various components of an intelligent and automatic user job/task assignment engine.

FIG. 8 illustrates functions of the intelligent and automatic user job/task assignment engine of FIG. 7.

The drawings described herein are for illustration purposes only and are not intended to limit the scope of the present disclosure in any manner.

### DETAILED DESCRIPTION

The disclosure will now be described in detail hereinafter with reference to the accompanied drawings, which form a part of the present disclosure, and which show, by way of illustration, specific examples of embodiments. The disclosure may, however, be embodied in a variety of different forms and, therefore, the covered or claimed subject matter is intended to be construed as not being limited to any of the embodiments to be set forth below. Further, the disclosure may be embodied as methods, devices, components, or systems. Accordingly, embodiments of the disclosure may, for example, take the form of hardware, software, firmware or any combination thereof.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

Modern machine learning or artificial intelligence (AI) applications/tasks may require careful tuning and resource prediction depending on the hardware architecture used to run these applications/tasks as well as business requirements (e.g., computational time and/or cost). In general, high-performance computing (HPC) clusters such as computing resources distributed in a cloud typically consist of a diverse set of hardware (CPU, GPU, FPGA, etc.) and memory architecture shared by a large number of user computational jobs or tasks. The terms “user job” and “user task” are used interchangeably in this disclosure. Under these circumstances, minimization of cost of utilizing a large computing cluster and maintaining optimal performance for the submitted user applications/tasks may be affected by both predictable events (such as the priority of the submitted applications) and unpredictable events (such as early termination of running jobs which frees up previously occupied computing resources). Traditionally, the selection of hardware architecture and resource adjustment in the computing cluster for user jobs/tasks mainly rely on manual rules and estimates provided by human operators and experts, which leads to inefficiencies, performance degradations, and wasted computing resources.

In this regard, more advanced techniques and algorithms may be constructed to build efficient and intelligent systems that are capable of comprehending and responding at multiple levels to both predictable and uncertain events to dynamically select/suggest hardware architecture, to predict computing resource requirement for user applications/tasks, to tune the user applications (e.g., tuning the machine learning and AI models used in the user applications), and to assign user tasks to computing resources based on both performance target metrics and resource availability, cost, and other constraints.

The present disclosure describes a system, a method, and a product for computational resource prediction of user applications/tasks and subsequent workload provisioning. The computational resource predictions for a user job/task may be achieved using a resource prediction twin machine learning and AI system based on, for example, generative modeling and probabilistic programing. Such a resource prediction twin may provide metrics of interest and tradeoffs between hardware, runtime, and cost metrics to the user for their submitted jobs/tasks. As an example generative model, the resource prediction twin may be further configured to self-improve or evolve over time via probabilistic programing. The workload scheduling and assignment of the user tasks in a computing cluster with components having diverse hardware architectures may be provisioned by an automatic and intelligent assignment/provisioning engine, which may be based on various machine learning and AI models. The automatic workload scheduling and assignment engine may be configured to handle unpredicted uncertainty and adapt to constantly evolving system queues of the tasks submitted by the users to generate queuing/re-queuing, running/termination, and resource allocation/reallocation actions for user tasks. The automatic workload scheduling and assignment engine may be configured to self-improve and evolve via deep reinforcement learning. The methods and systems disclosed herein improve computational resource allocation and provisioning efficiency using AI and other optimization techniques.

While the example embodiments below are described in the context that the user applications/tasks themselves are based on machine learning and AI models that may be trained and tuned according to performance targets and computational resource constraints, the principles underlying the resource prediction twin and the workload scheduling, assignment and provisioning engine are applicable to other user tasks and applications that do not involve machine learning and AI models.

By way of reference, related U.S. application Ser. No. 16/749,717 entitled “Resource-Aware Automatic Machine Learning System” filed on Jan. 22, 2020, and U.S. application Ser. No. 17/182,538 entitled “Resource Prediction System for Executing Machine learning Models” filed on Feb. 23, 2021, both belonging to the current applicant, are incorporated herein by reference in their entireties.

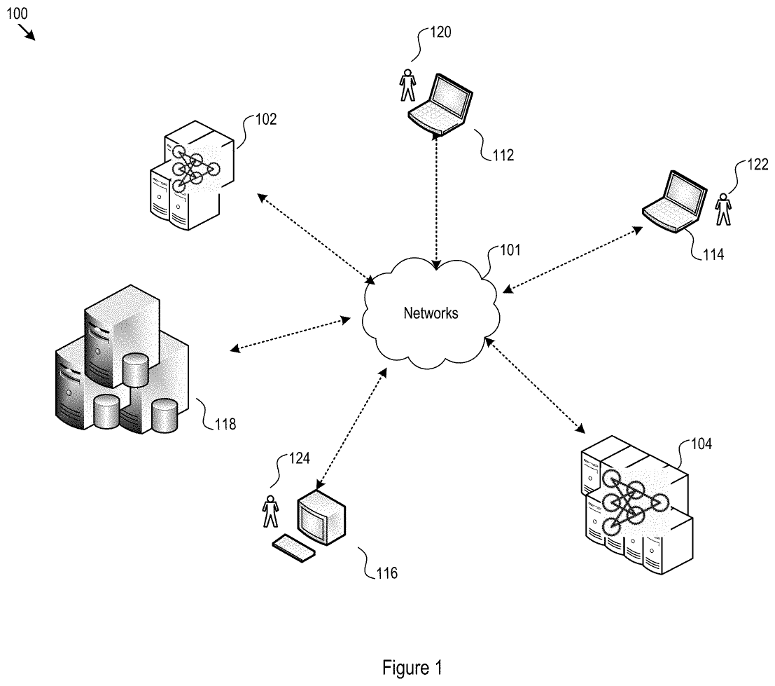

FIG. 1 shows an exemplary electronic communication environment 100 in which a system for computational resource prediction, resource-aware model tuning, and subsequent workload provisioning in a computer cluster may be implemented. The electronic communication environment 100 may include one or more servers (102 and 104) including the computational resource prediction, resource-aware model tuning, and subsequent workload system, and one or more user devices (112, 114, and 116) associated with users (120, 122, and 124), and one or more databases 118. These components may be in communication with each other via public or private communication networks 101.

The servers 102 and 104 may be implemented as a central server or a plurality of servers distributed in the communication networks. While the servers 102 and 104 shown in FIG. 1 are implemented as single servers, they may be also implemented as a group of distributed servers or a server farm. The servers 102, 104, and the database 118 may further include one or more clusters of computing resources for running applications/tasks submitted by users 120, 122, and 124. The system for computational resource prediction, resource-aware model tuning, and subsequent workload provisioning may be implemented with respect to the one or more computer clusters. The one or more clusters of computing resources may be implemented as a cloud system and provided as a cloud service. The servers that run the computational resource prediction, resource-aware model tuning, and subsequent workload provisioning functions may themselves be part of the cloud.

The user devices 112, 114, and 116 may be any form of mobile or fixed electronic devices, including but not limited to a desktop personal computer, laptop computers, tablets, mobile phones, personal digital assistants, and the like. The user devices 112, 114, and 116 may be installed with a user interface for submitting user applications/tasks and for accessing the system for computational resource prediction, resource-aware model tuning, and subsequent workload provisioning. The one or more databases 118 of FIG. 1 may be hosted in a central database server, a plurality of distributed database servers, or in cloud-based database hosts. The database 118 may be organized and implemented in any form, including but not limited to the relational database containing data tables, a graphic database containing nodes and relationships, and the like. The database 118 may be configured to store the intermediate data and/or final results for implementing the machine learning system described in this disclosure.

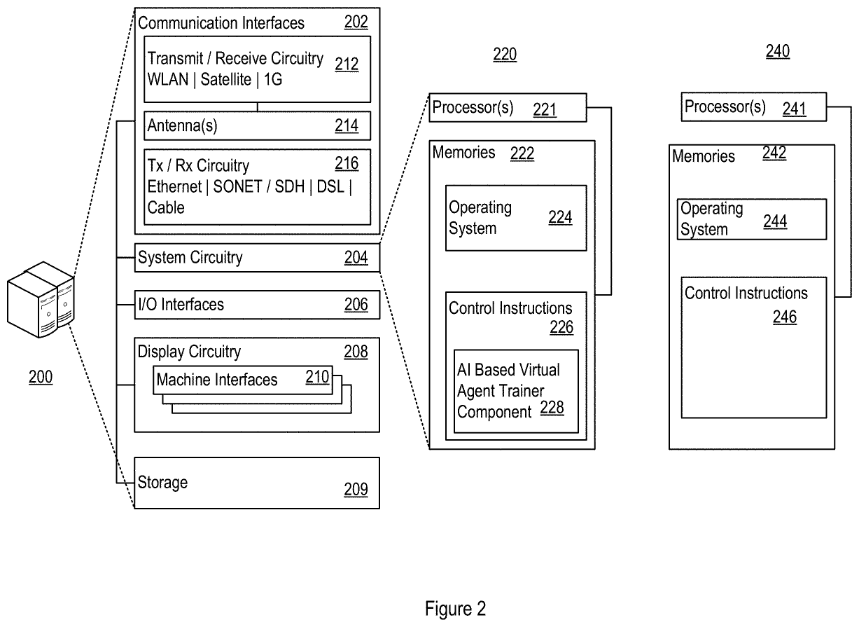

FIG. 2 shows an exemplary computing system 200 for implementing each of the servers, including the servers for computational resource prediction, resource-aware model tuning, and subsequent workload provisioning, the one or more computing clusters, or the user devices 112, 114, and 116. The computer system 200 may include communication interfaces 202, system circuitry 204, input/output (I/O) interfaces 206, storage 209, and display circuitry 208 that generates machine interfaces 210 locally or for remote display, e.g., in a web browser running on a local or remote machine. The machine interfaces 210, and the I/O interfaces 206 may include GUIs, touch-sensitive displays, voice or facial recognition inputs, buttons, switches, speakers, and other user interface elements. Additional examples of the I/O interfaces 206 include microphones, video and still image cameras, headset and microphone input/output jacks, Universal Serial Bus (USB) connectors, memory card slots, and other types of inputs. The I/O interfaces 206 may further include magnetic or optical media interfaces (e.g., a CDROM or DVD drive), serial and parallel bus interfaces, and keyboard and mouse interfaces.

The communication interfaces 202 may include wireless transmitters and receivers (“transceivers”) 212 and any antennas 214 used by the transmitting and receiving circuitry of the transceivers 212. The transceivers 212 and antennas 214 may support Wi-Fi network communications, for instance, under any version of IEEE 802.11, e.g., 802.11n or 802.11ac. The communication interfaces 202 may also include wireline transceivers 216. The wireline transceivers 216 may provide physical layer interfaces for any of a wide range of communication protocols, such as any type of Ethernet, data over cable service interface specification (DOCSIS), digital subscriber line (DSL), Synchronous Optical Network (SONET), or other protocol.

The storage 209 may be used to store various initial, intermediate, or final data or models for implementing the system for computational resource prediction, resource-aware model tuning, and subsequent workload provisioning. These data corpus may alternatively be stored in the database 118 of FIG. 1. In one implementation, the storage 209 of the computer system 200 may be integral with the database 118 of FIG. 1. The storage 209 may be centralized or distributed and may be local or remote to the computer system 200. For example, the storage 209 may be hosted remotely by a cloud computing service provider.

The system circuitry 204 may include hardware, software, firmware, or other circuitry in any combination. The system circuitry 204 may be implemented, for example, with one or more systems on a chip (SoC), application-specific integrated circuits (ASIC), microprocessors, discrete analog, digital circuits, and other circuitry.

For example, at least some of the system circuitry 204 may be implemented as processing circuitry 220 for the server 102, including the system for computational resource prediction, resource-aware model tuning, and subsequent workload provisioning of FIG. 1. The processing circuitry 220 of the system for computational resource prediction, resource-aware model tuning, and subsequent workload provisioning in a computer cluster may include one or more processors 221 and memories 222. The memories 222 store, for example, control instructions 226 and an operating system 224. The control instructions 226, for example, may include instructions for implementing the components 228 of the system for computational resource prediction, resource-aware model tuning, and subsequent workload provisioning. The hardware platform may include platforms associated with hardware devices, cloud instances, accelerators, and the like. A hardware device may further include representational state transfer (REST) application programming interface (API), simulator, a hardware target, and the like. In one implementation, the processors 221 may execute the control instructions 226 and the operating system 224 to carry out any desired functionality related to the system for computational resource prediction, resource-aware model tuning, and subsequent workload provisioning.

Alternatively, or in addition, at least some of the system circuitry 204 may be implemented as client circuitry 240 for the user devices 112, 114, and 116 of FIG. 1. The client circuitry 240 of the user devices may include one or more instruction processors 241 and memories 242. The memories 242 store, for example, control instructions 246 and an operating system 244. In one implementation, the instruction processors 241 execute the control instructions 246 and the operating system 244 to carry out any desired functionality related to the user devices.

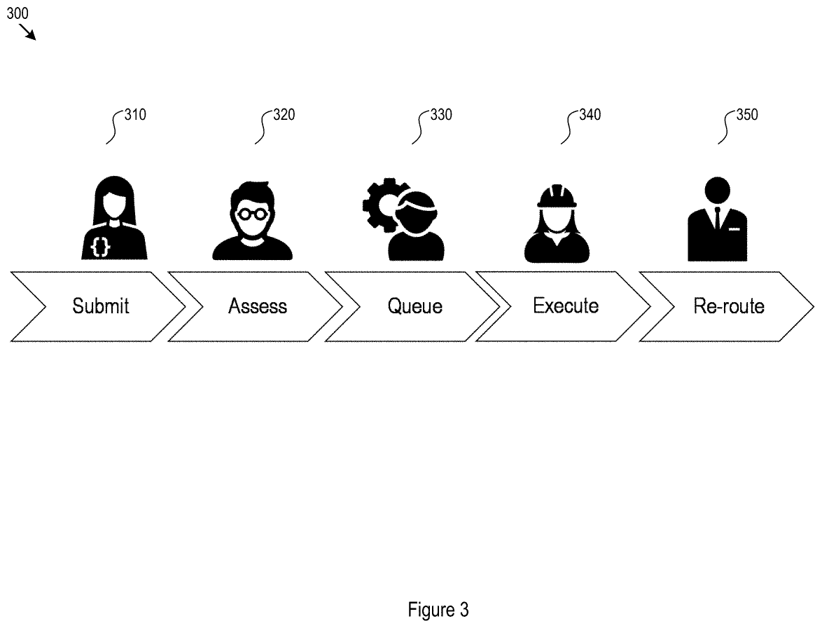

In the context of managing user tasks and applications in a shared HPC cluster, FIG. 3 illustrates an example traditional process flow 300. For example, the traditional process flow 300 may include user submission process 310, HPC computing resource access provisioning 320, task queue provisioning 330, user task execution provisioning 340, and adaptive task rerouting/redeployment provisioning 350. These traditional provisioning processes involve intervention by a technical and IT personnel with diverse and distinct sets of skills and expertise. Each person involved in the traditional process flow 300 may need to deal with different and conflicting objectives. For example, the user at the user submission process 310 may be concerned with time needed to run his/her own tasks, performance of and priority among his/her own submitted tasks, and tradeoff between resource (cost), queue time, and performance. An IT person managing the access to the HPC cluster in 320 may be concerned with overall resource availability at particular time horizon for all user tasks in the queue and priority among users, user groups, and user organizations/units. An IT person managing the task queue in 330 may be mainly concerned with resource unitization of the computing resources assigned/allocated at various levels (e.g., task level, user level, user group level, and organization level), and task queuing adjustment according to unpredicted changes in priority. An IT person for the user task execution provisioning 340 may be concerned with task termination/resumption based on task priority, wallclock time violation/exception, and other factors. An IT person handling the adaptive task rerouting/redeployment provisioning 350 may be concerned with rerouting tasks to resource allocated to other tasks when these resources are not fully utilized, and whether such rerouting would impact system resource utilization and priority. As illustrated above, the traditional process of user task provisioning flow 300 in an HPC cluster requires that various members of IT personnel interact iteratively in a complex manner, leading to implementation delays and non-optimal system operational efficiency.

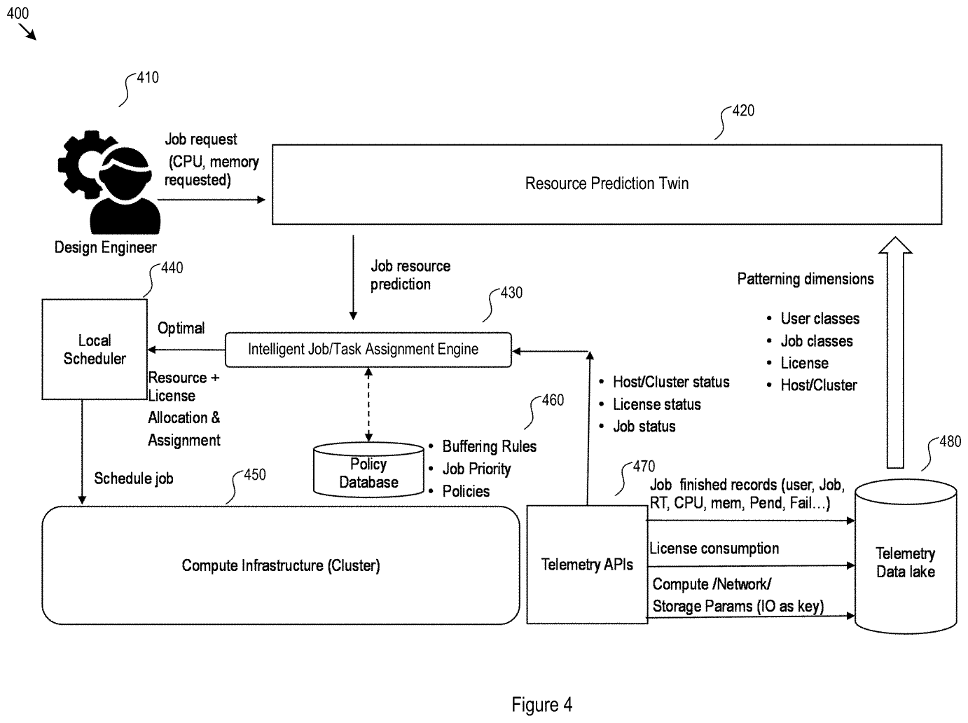

In contrast, FIG. 4 illustrates a process 400 for an automatic computational resource prediction and subsequent workload provisioning of user tasks and resource assignment in one or more HPC clusters relying on machine learning and AI modeling. For example, a user may initiate the process 400 by submitting an AI job/task request with a set of target metrics to a design engineer 410 who interacts with the rest of the process 400 by submitting AI jobs/tasks on behalf of users. The target metrics for example, may include expected prediction accuracy of the deployed user AI model, CPU processing requirement, memory requirement (e.g., 100 GB of memory), AI model information and the like.

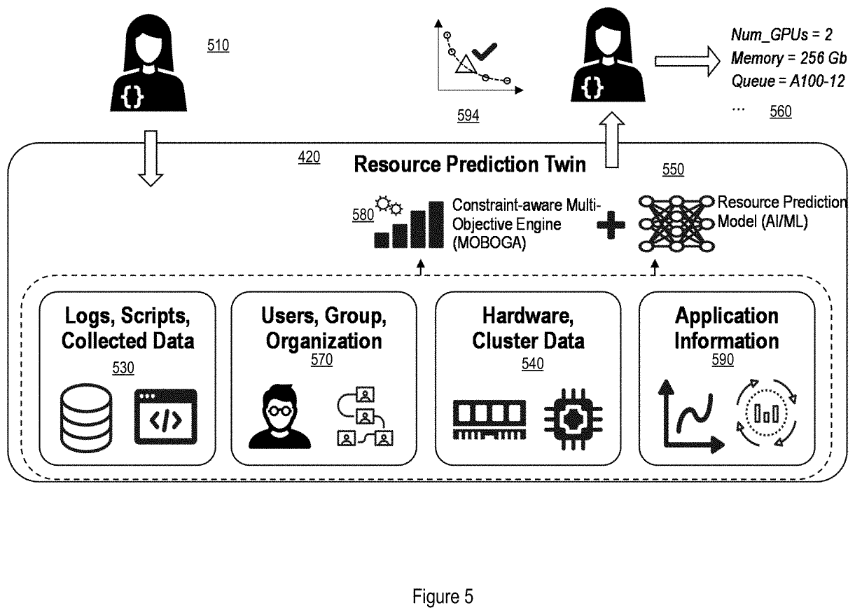

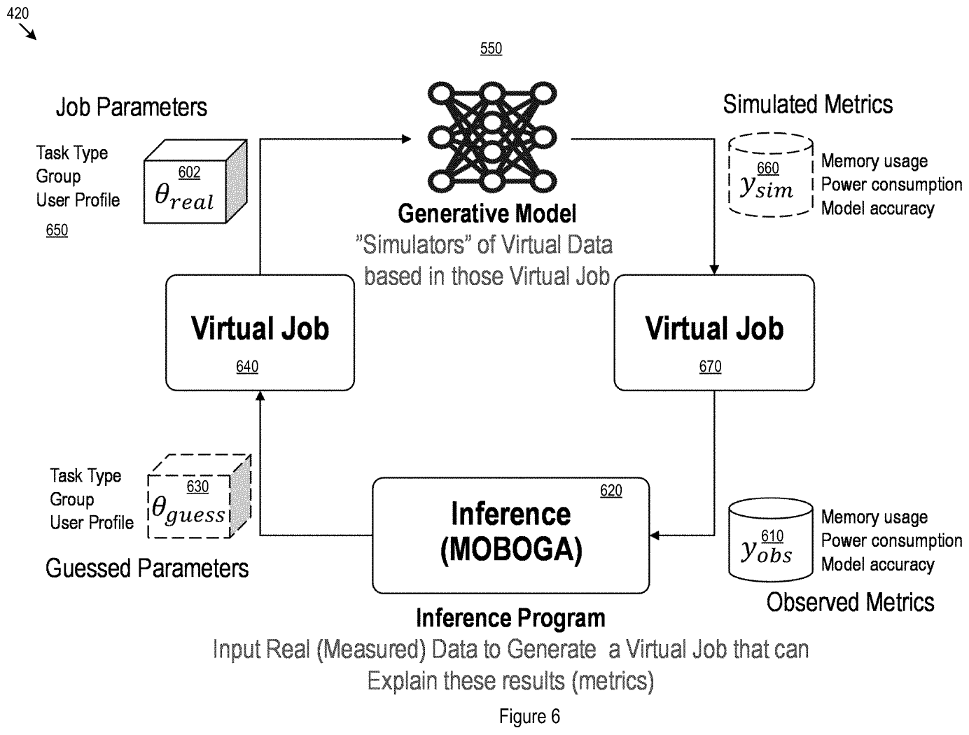

The user task parameters and metrics submitted by the user may then be processed/analyzed by an automatic computing resource prediction twin 420. The automatic resource prediction twin 420 (alternatively referred to as resource predication twin) may include one or more trained machine learning and AI models. For example, the resource prediction twin 420 may be based on a generative model that can self-improve or evolve using probabilistic programing. While it acts as a twin of the task submitted by the user, it may generate resource prediction by simulating the user task with respect to various types of hardware platforms and components without actually running or fully running the user AI models on the different hardware platforms. For example, the resource prediction twin 420 may be implemented by creating a hardware platform to run the resource prediction twin to compare various machine learning model's attributes and performances with respect to different hardware platforms (e.g., compare the power usage, cost, latency and accuracy of machine learning models on FPGA, GPU, CPU, etc.). Examples of the composition, training, and operation of the resource prediction twin 420 are described in U.S. application Ser. No. 17/182,538 entitled “Resource Prediction System for Executing Machine learning Models” filed on Feb. 23, 2021, which belongs to the same applicant of the instant application and is incorporated herein by reference in its entirety. Further description of the resource prediction twin 420 is provided below in relation to FIGS. 5-6.

In some implementations, the resource prediction twin 420 may perform resource prediction based on a user AI model architecture associated with a set of model hyper-parameters that have already been optimized elsewhere using, for example, the resource-aware machine learning system described in U.S. application Ser. No. 16/749,717 entitled “Resource-Aware Automatic Machine Learning System” filed on Jan. 22, 2020, herein incorporated by reference in its entirety, or other AI models. The resource prediction twin 420 may be mainly concerned with generating resource predictions with respect to various hardware platform and component recommendation based on the optimized architecture and hyper parameters of the user machine learning model. For example, a user AI model with the same model architecture (e.g., the same hyper parameters) may perform differently with different computing platforms or components and thus the resource prediction based on target metrics for the user AI may be platform-dependent.

In some implementations, in addition to the already optimized architecture and hyper parameters, the user machine learning model/task may have already been completely trained elsewhere and is input into the resource prediction twin 420 for resource prediction. The input user AI model to the resource prediction twin 420 may thus include both a set of hyper parameters and a set of trained model parameters.

In some other implementations, the resource prediction twin 420, in addition and together with resource prediction in various hardware platforms under the user specified target metrics or constraints (hardware usage, cost, time constraints, accuracy, and the like), may be configured to optimize the user AI model architectures represented by, for example, its hyper parameters based on some initial hyper parameters.

Correspondingly, the output of the resource prediction twin 420 may be configured in various forms. For example, the output of the resource prediction twin 420 may include resource prediction for each different computing platform according to the user task parameters and target metrics. The output may further include an indication of the optimal computing platform under user target metrics and constraints. For another example, the output of the resource prediction twin 420 may include optimized resource allocation for the input user task considering tradeoffs between various competing user target metrics or goals (e.g., tradeoff between reducing computing cost and minimizing run time). For another example, the output of the resource prediction twin 420 may include quantification of competing factors such as computing cost and performance of the user task in different computing platforms. For yet another example, the output of the resource prediction twin 420 may include optimized hyper parameters for the user task in addition to resource prediction.

As further shown in FIG. 4, the output of the resource prediction twin 420 may be provided to an intelligent job/task assignment engine 430. The intelligent job/task assignment engine 430 may include a trained machine learning and AI engine for generating resource assignment, task scheduling, and mapping between the various computing components/platforms in the HPC cluster 450 and the user tasks for queuing or deploying the submitted user task considering both system and individual metrics, competing or otherwise. The intelligent job/task assignment engine 430 may further base its resource assignment, task scheduling, and mapping on information retrieved from a resource assignment and allocation policy database 460 in addition to the resource prediction data provided by the resource prediction twin 420 for the user task at issue.

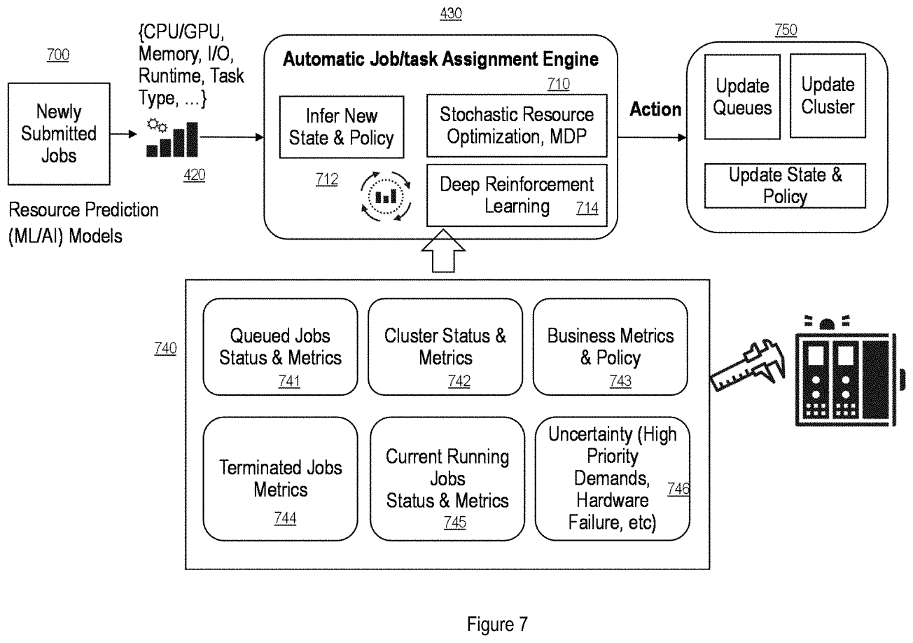

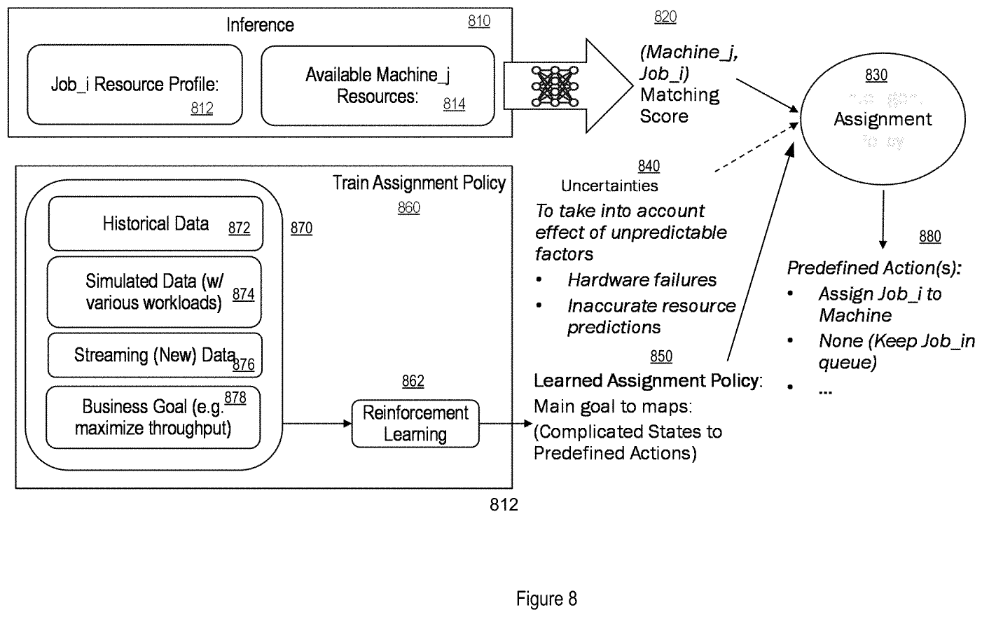

As shown in FIG. 4, the resource assignment and allocation policy, for example, may be related to various buffering rules, task priorities, and other computing resource allocation policies. As further described below, such policies may be generated and trained based on various historical data and may evolve and improve via reinforcement learning. The intelligent job/task assignment engine 430 may determine and adjust queuing, termination, execution, resource assignment and reassignment for user tasks periodically, when triggered, or under any other configurable conditions. The intelligent job/task assignment engine 430, for example, may evolve or self-improve via deep reinforcement learning of the assignment policy. The training and operation of the intelligent job/task assignment engine 430 are described in further detail below with respect to FIGS. 7 and 8.

Continuing with FIG. 4, the output from the intelligent job/task assignment engine 430 for the user task may be further provided to a local scheduler 440. The local scheduler 440 may further take hardware/software licensing information together with resource allocation and assignment output from the intelligent job/task assignment engine 430 in performing scheduling of the user task over the HPC cluster 450.

A telemetry Application Programming Interface (API) 470 associated with the HPC cluster 450 may be further provided for monitoring the status of the HPC cluster 450 with respect to, for example, hardware operating and usage status of the HPC cluster 450, hardware/software license consumption status, network and storage status, and status of the user tasks and jobs, as shown in FIG. 4. Such information may be fed back via the telemetry APIs to the intelligent job/task assignment engine 430 for dynamic and intelligent adjustment of resource allocation, user task re-routing, user task termination, and other actions. Such information may be used as data sources for reinforcement learning within the intelligent job/task assignment engine 430. Such information may also be fed back to the design engineer 410 for monitoring and inspection. Such information may be further stored in a telemetry data lake or database 480. As described in further detail below, information stored in the telemetry data lake 480 may be provided to and collected by the resource prediction twin 420 for training the generative model, and/or as input data for prediction purposes.

FIG. 5 shows an example implementation of the resource prediction twin 420. As a general matter, the resource prediction twin 420 may output a prediction of tradeoffs between the resources or types of resources (e.g., hardware, platform, cloud instances, and the like) against user target metrics, and provide an optimized resource recommendation for running the user machine learning model. Examples of items that the resource prediction twin 420 may output may represent (i) trade-off between estimated cost and runtime for a different number of GPUs or other processors and memory, (ii) cost and performance options for a certain job/task.

Additionally or alternatively, the resource prediction twin 420 may output the prediction of a resource additionally based on logs, scripts, and collected data 530, hardware data 540, and/or user/group/organization data 570. In the case of basing the resource prediction on the logs, scripts, and collected data 530, the resource prediction twin 420 may be configured to predict various computing resource metrics. For example, the resource prediction twin 420 may predict how long each job or task would take to complete if the user 510 desires to run the job on a GPU versus CPU with a certain configuration. In the case of basing the resource prediction on hardware data 540, the resource prediction twin 420 may further predict or adjust user machine learning or AI model parameters. For example, the resource prediction twin 420 may predict a user machine learning or AI model configuration that may satisfy target metrics under given resource constraints (e.g., memory and/or CPU limitations, etc.). In the case of basing the resource prediction on the user/group/organization data 570, the resource prediction twin 420 may predict computing resource considering user, group, and organization relationships and priorities. The data 530, 540, and 570 may be considered separately or holistically.

The resource prediction twin 420 may benefit the user 510 by generating predictions for how to satisfy several competing goals without running an actual machine learning model, or benchmarking different models against different sets of hardware platforms. In some implementations of the present disclosure and as shown by 580 of FIG. 5, the resource prediction twin 420 may utilize some model optimization and/or inference algorithm, such as the multi-objective Bayesian optimization genetic algorithm (MOBOGA) as disclosed in U.S. application Ser. No. 16/749,717 and herein incorporated by reference to provide inference needed in the probabilistic programming example for the resource prediction twin 420 described above with respect to FIG. 6. In some other implementations, the resource prediction twin 420 may combine the function of the resource-aware but platform independent user model optimization in U.S. application Ser. No. 16/749,717 and the resource prediction and optimization functions with respect to different potential hardware platforms in the HPC cluster.

In some other implementations, a hardware platform independent user machine learning and AI models may be optimized using a separately trained resource-aware model optimization algorithm (such as the MOBOGA). Model parameters (including hyper parameters and or trained parameters) of such separately optimized user machine learning and AI models and other user task information may be used as input to the resource prediction twin 420. Such task specific parameters may be collected and used as part of the data for training the resource prediction twin 420, as shown by 590 in FIG. 5.

In some implementations, the resource prediction twin 420 may utilize at its core a generative model 550 that is trained and then evolve based on inference and probabilistic programming. It may be trained based on parameters of the user machine learning model and measured (observed) metrics. The probabilistic programming system as used for the resource prediction twin 420 is explained further below with reference to FIG. 6.

In order to output the prediction of resource, the resource prediction twin 420 may be trained on a wide variety of data associated with different resources as shown by 530, 570, and 540 of FIG. 5. However, the capability of the resource prediction twin 420 to output the prediction of resource may further depend on the type of a machine learning model (e.g., time series prediction model, neural network architecture model, and the like), as indicated by 590 of FIG. 5.

The resource prediction twin 420 may output the resource prediction by providing the trade-off between optimized cases and their targeted objectives (e.g., inference time, memory, latency, model accuracy, and the like). These optimal cases may be represented by, for example, Pareto-Optimal options 595, as explained in U.S. application Ser. No. 16/749,717 and U.S. application Ser. No. 17/182,538, herein incorporated by reference. For example, in outputting the prediction of resource as shown in 560, the resource prediction twin 420 may provide trade-offs between estimated cost and runtime for a different number of GPUs and memory.

In some implementations, the resource prediction twin 420 may utilize a generative model trained using probabilistic programming. Using probabilistic programming may facilitate building generative models as programs to solve an inference problem from observed incomplete data. By providing the data generation process as a program, the probabilistic programming approach may perform the inference problem. The uncertainties in these estimated and inferred parameters may also be quantified. Therefore, probabilistic programming may help capture the real-world process of data generation, whereas traditional or conventional machine learning models perform feature engineering and transformation to make data fit into a model.

In some implementations, a probabilistic model (e.g., in the form of relationship between metrics y and job/task parameters x: y=θ₁x₁+θ₂x₂+ . . . , where θ represents the model parameters of the probabilistic model) to predict metrics y such as memory usage, power consumption, model accuracy from job/task parameters x. Some measured or observed metrics data may have been collected. The goal of the probabilistic programing is to determine and improve the model parameters θ for the generative model. One example way is to first guess the distribution of the θ parameters (guessed parameters) based on an inference of θ and the observed metrics, and simulate a distribution of the metrics (memory usage, power consumption, model accuracy). Then when new data comes in, the model is used to make an inference.

FIG. 6 shows an example implementation of using probabilistic programing for obtaining and improving a generative model 550 of the resource prediction twin 420 for resource prediction. The generative model 550 may consist of a set of model parameters θ 602. As shown in FIG. 6, an initial generative model 550 may be obtained based on existing training data shown as 530, 570, 540, and 550 of FIG. 5. The generative model 550 may be capable of processing a set of job/task parameters 650 associated with an input user task. These job/task parameters may include, for example, as discussed in relation to element 410 of FIG. 4, user AI model information and a set of target metrics including expected predicted accuracy of the deployed user AI model, CPU requirement, memory requirement and the like.

The generative model 550 start with job/task parameter 650 as its guessed model parameters θ, based on the observed metrics 610 (including, for example, memory usage, power consumption, and model accuracy may be collected). The model is able to obtain simulated metrics 660 by generating virtual job(s) 670. The simulated metrics 660 may include, for example, simulated memory usage, power consumption, model accuracy for the user task. The observed metrics 610 and the simulated metrics 660 by the generative model 550 may be received at an inference model 620. The inference model 620 may process the observed metrics 610 and the simulated metrics 660 and generate probabilistic models that can explain the input metrics. The inference model 620 may be used to infer a set of guessed model parameters 630 and their distributions for the generative model 550 by generating second virtual jobs 640 to infer a new set of model parameters θ for the generative model 550.

In one example application of the resource prediction twin 420, a user through the design engineer 410 of FIG. 4 may want to know, for example, which machine learning model of various user models would be a suggested machine learning model to run under user-defined objectives input to the system as targeted objectives. For example, the user via design engineer 410 may have defined objectives of hardware with 80% accuracy and 100 GB of memory, which is input as targeted objective to the resource prediction twin 420. Without executing an actual machine learning model (real job), the resource prediction twin 420 may use the inference model 620 of FIG. 6 to infer necessary model parameters (initializing the generative model's guessed model parameters 630, and obtaining the real model parameters 602, aka virtual job, after running probabilistic programming) in order to achieve the targeted objective. Then, the resource prediction twin 420 may generate and utilize the second virtual job(s) 640 to improve the model parameters 602 for the generative model 550 for predicting or simulating metrics from input user task data 650.

FIG. 7 shows an example implementation of the automatic and intelligent job/task assignment engine 430 of FIG. 4. As shown in FIG. 7, the resource predictions for a user-submitted job/task 700 generated by running the resource prediction twin 420 may be provided to the automatic and intelligent job/task assignment engine 430. The automatic and intelligent job/task assignment engine 430 may assign or map a job/task associated with the predictions to computing resources and platforms within the HPC cluster and automatically provision the job/task queues. The automatic and intelligent job/task assignment engine 430 may determine and optimize selection of computing resources and platform to perform the job/task based on the prediction output by the resource prediction twin 420 and a set of metrics data 740, including but not limited to, queued jobs status metrics 741, computing cluster status and metrics 742, business metrics and policies 743, terminated jobs and their metrics 744, current running job status and metrics 745, and uncertainties 746 (e.g., high priority demands, hardware failure, and the like).

The automatic and intelligent job/task assignment engine 430 may be configured as a separate machine learning model (such as a regression model or a neural network) in order to automatically and adaptively determine the optimized resource assignment among the computing resources within the HPC cluster and provision various job/task queues.

The automatic job/task assignment engine 430 may include a robust machine learning and inference model plus intelligent policies to provide optimal schedules while dealing with uncertainties and inaccuracies inherent to other prediction models. The automatic job/task assignment engine 430 may go beyond using simple heuristics by further taking into account workloads and unpredicted uncertainties, and keep various policies updated automatically and efficiently.

In some implementations, the automatic and intelligent job/task assignment engine 430 may include component 710 for resource selection and optimization (e.g., stochastic resource optimization such as Markov Decision Process (MDP)), and component 712 for state and policy inference, and component 714 for performing deep reinforcement learning.

The output of the automatic and intelligent job/task assignment engine 430 may include action items 750. An action item with respect to the submitted user job/task may be automatically triggered and executed by the automatic and intelligent job/task assignment engine 430. The action items 750 may be directed to job/task assignment and/or queue provisioning, including, for example, an update of the job queue, an update of the HPC cluster information, and update of HPC and various other states and scheduling/assignment policies.

In some implementations, the automatic and intelligent job/task assignment engine 430 may include a machine learning model that maps the various input data, including the resource prediction generated by the resource prediction twin 420 and other data in 740, or their transformed forms, to one or more action items among a set of possible action items. The set of action items may be predefined action classes and may be expanded during deep reinforcement learning of the intelligent job/task assignment engine 430. Such mapping may be performed according to a trained policy as shown in component 712 applied to input data associated with input job/task 800 and metrics data 740.

FIG. 8 further illustrates several example functions of the automatic and intelligent job/task assignment engine 430. For example, 810 illustrates the inference and mapping function. The inference or mapping function may be configured to process a job/task resource profile 812 and available machine resources 814 to generate a matching score 820 between a particular input job/task and a particular computing device/system. The job/task resource profile 812 for a corresponding job/task may include, for example, memory requirement prediction, CPU/GPU prediction, and I/O bandwidth prediction, and the like. The available resources as indicated by 814 may include for example, a profile of computing resources of available computing devices, including memory capacity, CPU/GPU capability, I/O bandwidth, ETA runtime, and the like. The matching scores generated via the inference function 810 may be provided to the intelligent resource assignment function 830 to generate the predicted actions as shown in 880.

The intelligent job/task assignment function may further consider unpredicted uncertainties 840 and may be based on the assignment policies 850. The uncertainties for example, may include unpredicted hardware failures and inaccurate resource predictions by the resource prediction twin. Historical occurrences of these unpredicted uncertain events may be considered by the assignment function in addition to the machine-job matching scores 820 and the assignment policy 850 in generating the predicted action among the set of predefined scheduling actions 880 by a resource assignment function 830. The predefined set of scheduling actions including but not limited to assigning the job/task to a computing resource, and keeping the job/task in the task queue.

The assignment policy 850 as one of the input items considered by the resource assignment function 830, for example, may be generated by a trained machine learning model as shown by 860 of FIG. 8 which may be further improved via reinforcement learning 862. The training and reinforcement learning of the assignment policy may be based on initial and updated data 870, which may include but are not limited to historical data 872, simulated data 874 (with various workloads), new streaming data 876 added as the intelligent job/task assignment engine is being used, and data 878 related to business goals (such as maximizing computing throughput of the HPC cluster). The assignment policy 850 obtained via the reinforcement learning 862 facilitates a mapping between a complicated input states to the predefined actions 880.

The resource prediction twin machine learning model 420 described above for outputting predictions and the automatic and intelligent assignment/workload provisioning engine 430 may provide metrics of interest to the user for their submitted jobs/tasks. In addition, the twin machine learning models are able to handle uncertainty and automatically adapt to constantly evolving system queues and the submitted jobs via inference and reinforcement learning. Further, because the resource prediction twin machine learning model 420 provides the prediction of various metrics (e.g., accuracy, latency, memory consumption fora given model), engineers (e.g., Machine Learning engineer, deployment engineer) may use these models to help reduce the time and overall cost of operations. As such, the resource prediction twin machine learning model 420 may be used as a platform to explore various scenarios under which these machine learning models can be retrained and deployed. For example, the twin machine learning models and workload provisioning system may be utilized in intelligent and system-aware job assignments on high performance computing/clusters.

The resource prediction twin 420 and the intelligent assignment/workload provisioning engine 430 may be performed by a circuitry. The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

While the particular disclosure has been described with reference to illustrative embodiments, this description is not meant to be limiting. The attached appendix is part of this disclosure, and is incorporated herein as further illustrative embodiments. Various modifications of the illustrative embodiments and additional embodiments of the disclosure will be apparent to one of ordinary skill in the art from this description. Those skilled in the art will readily recognize that these and various other modifications can be made to the exemplary embodiments, illustrated and described herein, without departing from the spirit and scope of the present disclosure. It is therefore contemplated that the appended claims will cover any such modifications and alternate embodiments. Certain proportions within the illustrations may be exaggerated, while other proportions may be minimized. Accordingly, the disclosure and the figures are to be regarded as illustrative rather than restrictive.

What is claimed is:

1. A system comprising:
a computer cluster including a set of computing platforms each corresponding to one of a plurality of different computing architectures; and
an automatic and adaptive resource prediction and assignment circuitry for scheduling user tasks on the computer cluster, the circuitry being configured to:
receive input data, the input data comprising platform-independent task parameters and target metrics associated with a user task;
automatically generate a computing architecture and computing platform selection and computing resource prediction based on the input data and a hardware profile of the computer cluster using a computing resource prediction engine;
automatically map the user task to one or more of the set of computing platforms and to a scheduling action among a set of scheduling actions using a trained intelligent computing resource assignment engine;
automatically schedule the user task according to the scheduling action; and
automatically adjust the trained intelligent computing resource assignment engine by applying reinforcement learning based on newly acquired data associated with performing the scheduling action.

2. The system of claim 1, wherein the user task comprises a machine learning model.

3. The system of claim 2, wherein the machine learning model comprises a set of hyper parameters that are separately optimized using a Bayesian optimization genetic algorithm.

4. The system of claim 2, wherein the machine learning model comprises a set of hyper parameters that are optimized together with the computing architecture and computing platform selection and computing resource prediction by the computing resource prediction engine using a Bayesian optimization genetic algorithm.

5. The system of claim 1, wherein the computing resource prediction engine is based on probabilistic programing.

6. The system of claim 5, wherein the computing resource prediction engine comprises a generative model for simulated metrics.

7. The system of claim 6, wherein the target metrics and simulated metrics comprises at least one of memory usage, power consumption, and model accuracy metrics.

8. The system of claim 6, wherein the generative model comprises a set of model parameters that evolve according to an inference based on measured task metrics.

9. The system of claim 8, wherein the inference is performed using a Bayesian optimization genetic algorithm.

10. The system of claim 1, wherein the intelligent computing resource assignment engine is configured to:
perform the mapping based on the computing architecture and computing platform selection and computing resource prediction, and at least one of queued user job metrics, the hardware profile of the computer cluster, business metrics, terminated task metrics, current task metrics, historical task data, new task data, or uncertainties.

11. The system of claim 10, wherein the uncertainties comprise unpredicted factors including at least one of a hardware failure and an inaccurate resource prediction.

12. The system of claim 10, where the set of scheduling actions comprises at least assigning the user task according to the computing architecture and computing platform selection and computing resource prediction and keeping the user task in a task queue.

13. A method for scheduling user tasks on a computer cluster including a set of computing platforms each corresponding to one of a plurality of different computing architectures, the method comprising:
receiving input data, the input data comprising platform-independent task parameters and target metrics associated with a user task;
automatically generating a computing architecture and computing platform selection and computing resource prediction based on the input data and a hardware profile of the computer cluster using a computing resource prediction engine;
automatically mapping the user task to one or more of the set of computing platforms and to a scheduling action among a set of scheduling actions using a trained intelligent computing resource assignment engine;
automatically scheduling the user task according to the scheduling action; and
automatically adjusting the intelligent computing resource assignment engine by applying reinforcement learning based on newly acquired data associated with performing the scheduling action.

14. The method of claim 13, wherein the user task comprises a machine learning model.

15. The method of claim 14, wherein the machine learning model comprises a set of hyper parameters that are separately optimized using a Bayesian optimization genetic algorithm.

16. The method of claim 14, wherein the machine learning model comprises a set of hyper parameters that are optimized together with the computing architecture and computing platform selection and computing resource prediction by the computing resource prediction engine using a Bayesian optimization genetic algorithm.

17. The method of claim 13, wherein the computing resource prediction engine is based on probabilistic programing.

18. The method of claim 17, wherein the computing resource prediction engine comprises a generative model for simulated metrics.

19. The method of claim 13, wherein the intelligent computing resource assignment engine is configured to:
perform the mapping based on the computing architecture and computing platform selection and computing resource prediction, and at least one of queued user job metrics, the hardware profile of the computer cluster, business metrics, terminated task metrics, current task metrics, historical task data, new task data, or uncertainties.

20. A non-transitory medium for storing computer readable instructions, the computer readable instructions, when executed by a processor, are configured to cause the processor to schedule user tasks on a computer cluster including a set of computing platforms each corresponding to one of a plurality of different computing architectures by:
receiving input data, the input data comprising platform-independent task parameters and target metrics associated with a user task;
automatically generating a computing architecture and computing platform selection and computing resource prediction based on the input data and a hardware profile of the computer cluster using a computing resource prediction engine;
automatically mapping the user task to one or more of the set of computing platforms and to a scheduling action among a set of scheduling actions using a trained intelligent computing resource assignment engine;
automatically scheduling the user task according to the scheduling action; and
automatically adjusting the intelligent computing resource assignment engine by applying reinforcement learning based on newly acquired data associated with performing the scheduling action.
